(19) United States
(12) Patent Application Publication
(10) Pub. No.: US 2013/0325832 A1
(43) Pub. Date: Dec. 5, 2013

(54) PRESENTING SEARCH RESULTS WITH CONCURRENTLY VIEWABLE TARGETS

(71) Applicants: Charles French, Cupertino, CA (US); Timothy Edgar, Bellevue, WA (US); Tarek Fares Ayna, Redmond, WA (US); Nathan Deepak Jhaveri, Seattle, WA (US)

(72) Inventors: Charles French, Cupertino, CA (US); Timothy Edgar, Bellevue, WA (US); Tarek Fares Ayna, Redmond, WA (US); Nathan Deepak Jhaveri, Seattle, WA (US)

(73) Assignee: Microsoft Corporation, Redmond, WA (US)

(21) Appl. No.: 13/485,652

(22) Filed: May 31, 2012

(51) Int. Cl. G06F 17/30

(52) U.S. Cl. 707/706; 707/722; 707/E17.108

(57) ABSTRACT

A user of a device may formulate a search query that results in a presentation of search results set, and a selection of a search result may cause the device to present the target of the selected search result. However, in many scenarios, the target replaces or overlaps the search results set, and a user wishing to review the search results set or select a different search result must re-execute the search query or toggle between the search results set and respective targets. Instead, the search results set may be presented concurrently with a target of a selected search result. Upon selection of a search result, the device may be configured to resize the search results set to a condensed search results region, and present the target of the selected search result in a target region that is concurrently viewable with and not overlapping the condensed search results region.

### BACKGROUND

In the field of computing, many scenarios involve a search query formulated by a user and the presentation to the user of a set of search results. The search query may comprise, e.g., a web search of web resources; a file search of a file system; an email search within a message mailbox; or a database search involving a query formulated in a query language, such as a variant of the Structured Query Language (SQL). The set of search results is often presented as a list that provides details about each target in the search domain that matches the search query, possibly sorted by various criteria (e.g., the predicted relevance of the target to the search query, or the age of the target). Moreover, the device presenting the search results may allow a user to select a target in the search results, and may present the target of the search result (e.g., by loading a web page represented by a search result in the same or a different browser window, or by invoking an application to render a file identified in a file search).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The presentation of search results in a computing environment may present some inefficiencies. For example, when a user invokes a particular search result presented in a region (such as a window), the target associated with the search result may replace the search results in the region, but the user may wish to view other search results or revise the search query. Returning to the search results may involve navigating back from the invoked search result to the search results set, or even re-executing the query (which may involve a delay, and/or may present different search results). Alternatively, the search results may be presented in a separate region than an invoked target, such as a separate tab of a tabbed user interface or a separate window of a windows user interface. However, these interfaces may alternate with or partially or completely overlap or underlap the search results. In order to view both the list of search results and the targets of selected search results, the user may have to position the regions manually (e.g., manually moving and resizing the search results list and the target window) and/or alternate between overlapping regions (e.g., toggling between a first tab containing the list of search results and a second tab containing the target). Moreover, viewing additional targets may involve additional toggling and/or manual positioning.

Presented herein are techniques for configuring a device to present search results in a manner that enables a concurrent viewing of the targets associated with the search results. Initially, upon receiving a search query of a device, the device presents the search results in a search results region of a display of the device. However, when a user selects a search result, the device resizes the search results region to a condensed search results region that presents condensed versions of the search results, and presents the target of the selected search result in a target region that does not overlap the condensed search results region. This presentation enables the user to view the target of the selected search result while concurrently continuing to view the other search results. Moreover, the selection of additional search results in the condensed search results region reuses the same target region to present the associated targets of the additionally selected search results. In this manner, the user may view the targets of selected search results while continuing to view the search results, and without having to manually resize the search results region or the target region, through the use of the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation of search results provided by a search engine in response to a search query.

FIG. 2 is an illustration of an exemplary scenario featuring alternative presentations of search results provided by a search engine in response to a search query.

FIG. 3 is an illustration of an exemplary scenario featuring a presentation of search results provided by a search engine in response to a search query in accordance with the techniques presented herein.

FIG. 4 is a flow chart illustrating an exemplary method of presenting search results in response to a search query.

FIG. 5 is an illustration of an exemplary computer-readable medium comprising processor-executable instructions configured to embody one or more of the provisions set forth herein.

FIG. 6 is an illustration of an exemplary scenario featuring various presentations of search results in response to various gestures in the context of a presentation of a particular search result.

FIG. 7 is an illustration of an exemplary scenario featuring an implementation of the techniques presented herein in the context of a search engine providing search results to a device for rendering within a web browser.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of computing, many scenarios involve the presentation of search results in response to a search query. As one such example, a search engine may be configured to “crawl” a network (such as the internet or a local area network) to discover and index web resources, and may fulfill a search query by providing references to web resources that match the terms of the search query. Similar search query fulfillment may be conducted in the context of an email server indexing a set of email messages in an email inbox; a file server indexing a set of files; and a database server storing a set of records. These scenarios result in the presentation of a set of search results to the user that describe the targets identified by the search engine as related to the search query, and the user may select a particular search result to view or interact with the target represented thereby.

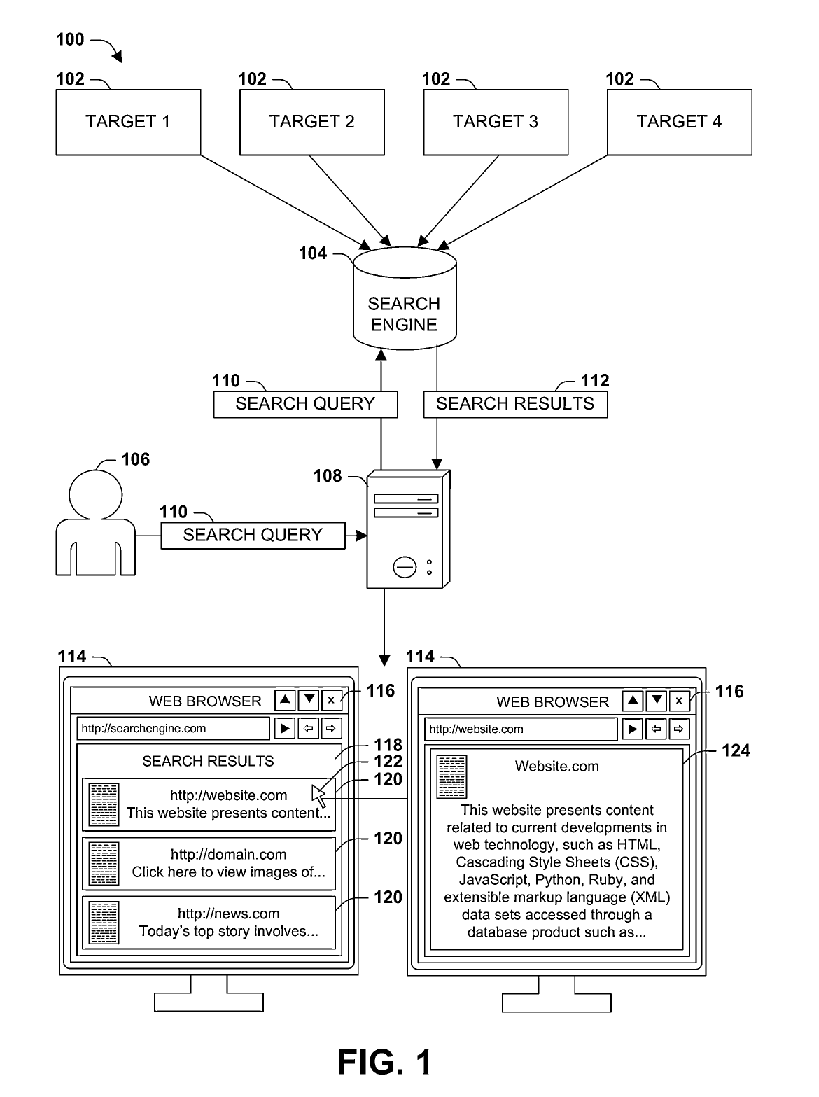

FIG. 1 presents an illustration of an exemplary scenario 100 featuring a presentation of search results generated in response to a search query 110. In this exemplary scenario 100, a search engine 104 that is configured to fulfill search queries indexes a set of targets 102. A user 106 of a device 108 may submit a search query 110 (e.g., a set of keywords or a set of criteria describing a desired set of targets 102, and/or a Boolean logical structure whereby the search query 110 is to be evaluated). The search engine 104 may compare the search query 110 to the indexed targets 102 (either using a precompiled index generated through an earlier inspection of targets 102 for prospective use in subsequently received search queries 110, or an ad hoc index created in response to the receipt of the search query 110), and may present to the device 108 a set of search results 112 that describe the targets 102 identified as satisfying the search query 110. These search results 112 may be presented on a display 114 of the device 108. For example, in the context of a web search conducted through a web browser 116 executing on the device 108 and submitted to a web search engine 104, the search results 112 may be presented as a web search results page 118 within the web browser 116, comprising a set of hyperlinks 120 that describe respective web pages that are identified as satisfying the web search. Moreover, the user 106 may select a hyperlink 120 in the web search results page 118 of the web browser 116 (e.g., by pointing a cursor 122 at the hyperlink 120 and clicking a button of a pointing device such as a mouse), resulting in a rendering of the target web page 124 identified by the hyperlink 120 (i.e., the target 102 associated with the search result 112 selected by he user 106). In this manner, the user 106 may utilize the information presented on the web search results page 118 to identify a target 102 of interest, and to navigate to the target web page 124 described by the search result 112.

However, the exemplary scenario 100 of FIG. 1 presents some disadvantages in the presentation of search results 112 in response to the search query 110. In particular, when the user 106 navigates to the target 102 of a search result 112, the web browser 116 loads the target 102 by replacing the search results 116. In order to reexamine the search results 112 or select another target 102, the user 106 may have to navigate back to the web search results page 118, and thus cannot continue viewing the first selected target 102 in the web browser 116. Additionally, navigating back to the web search results page 118 may involve a delay in re-rendering the web search results page 118 (which may be nontrivial on a low-powered device, such as a mobile phone). Moreover, if the web browser 116 has not cached the web search results page 118 and has to reload it from the search engine 104, the navigation back to the web search results page 118 may involve an unnecessary additional delay and/or expenditure of bandwidth in the re-transmission of the search query 110 and the receipt of the search results 112, and may present a different set of search results 112 (e.g., the index of the search engine 104 may have changed since the search query 110 was first received; or the search engine 104 may “rotate” some search results, such as advertisements, and may thus not present the same set of search results 112 for successive identical search queries 110).

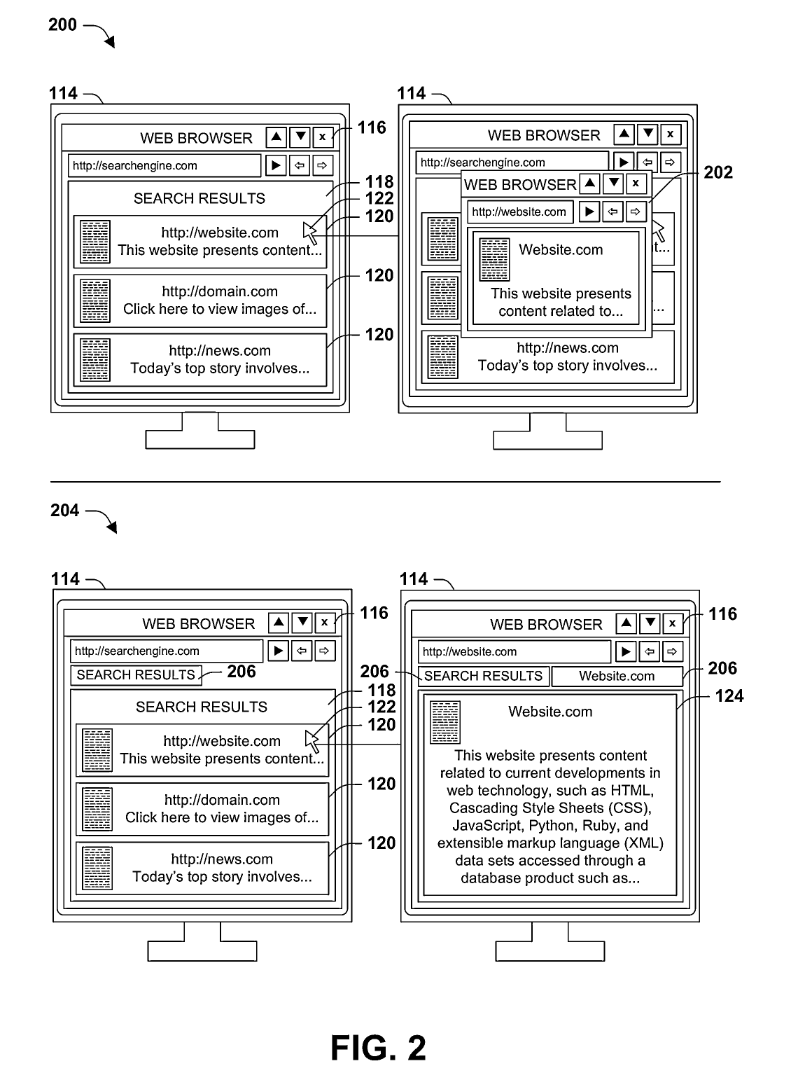

Other techniques for presenting search results 112 in response to a search query 110 may alleviate some of these disadvantages, but may present other disadvantages. FIG. 2 presents two such alternative presentations of search results 112. As a first alternative 200, rather than replacing the web search results page 118 with the target web page 124, the web browser 116 may present a popup window 202 wherein the target web page 124 may be rendered. This first alternative 200 enables the user 106 to continue examining the search results 112 without having to reload either the search results web page 118 or the target web page 124. However, the overlapping presentation of the popup window 202 presenting the target web page 124 and the web browser 116 presenting the search results web page 118 may compel the user to toggle between these interfaces. Alternatively, the user 106 may manually resize the web browser 106 and the popup window 202, e.g., as a side-by-side appearance. However, in addition to involving the manual resizing of the windows by the user (which may be irritating and/or time-consuming), this resizing may reduce either the web browser 114 or the popup window 202 into an undesirably small viewport, thus reducing either the search results 112 or the target web page 124 to an undesirably small area.

As a second example 204 presented in FIG. 2, the web browser 116 may present a tabbed user interface, comprising a set of tabs 206 for respective concurrently loaded web pages, and a user 106 may toggle among the tabs 206 to view the associated web pages without reloading. The search results 112 may be presented in a first web page associated with a first tab 206, and the targets 102 of respective selected search results 112 may be presented in other tabs 206. This example enables the user 106 to toggle among the search results 112 and the targets 102 without reloading. However, the user 106 is still unable to view the search results 112 concurrently with the targets 102; e.g., in order to view several targets 102, the user 106 has to select a first search result 112, switch to a tab for the first target 102, switch back to the tab 206 for the search results web page 118 in order to select a second search result 112, switch to a tab for the second target 102, switch back to the tab 206 for the search results page 118 in order to select a third search result 112, etc. This tabbed user interface therefore adds complexity to the navigation among the set of search results 112 and the selected targets 102, and does not enable concurrent viewing thereamong.

### B. Presented Techniques

Presented herein are techniques for presenting search results 112 generated in response to a search query 110 in a manner that facilitates the user's exploration of the search results 112 by enabling concurrent viewing of the search results 112 and associated targets 102. Moreover, these techniques may enable such concurrent viewing without reloading either the search results 112 or the targets 102, and/or may avoid manual resizing and repositioning of windows by the user 106.

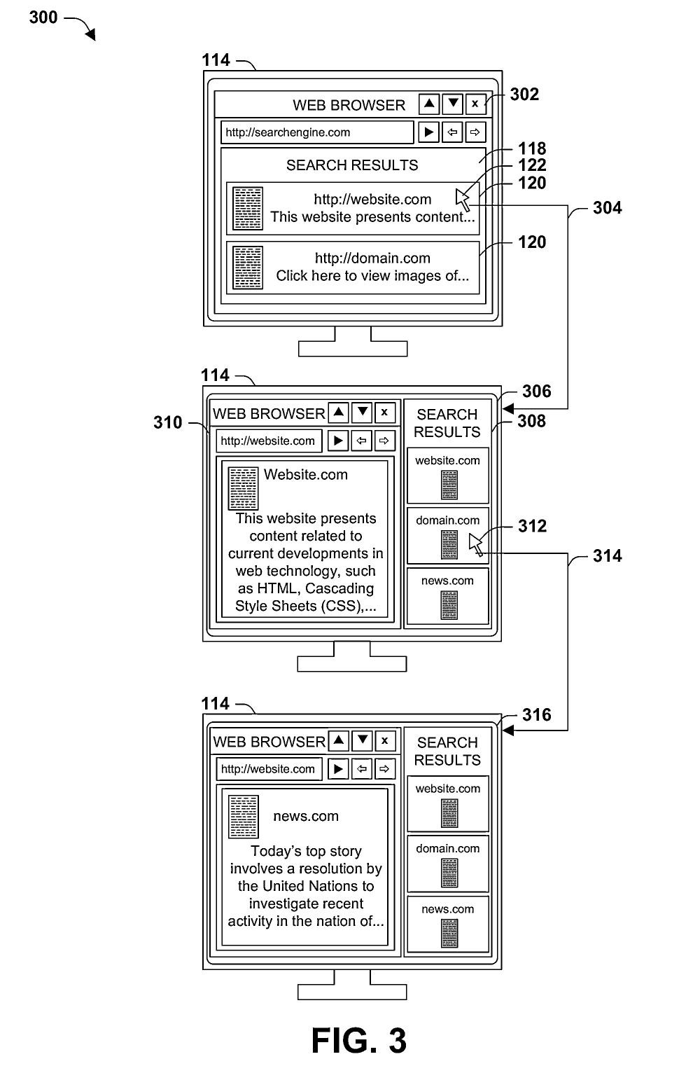

FIG. 3 presents an illustration of an exemplary scenario 300 featuring a presentation of search results 112 according to the techniques presented herein. In this exemplary scenario 300, when a user 106 submits a search query 110 to a search engine 104, the search engine 104 presented search results 112 that describe respective targets 102 as either a full version of the search result 112 (e.g., a description of the web page and an extended excerpt thereof) or a condensed version of the search result 112 (e.g., just the domain and title of the web page). The device 108 initially presents full versions of the search results 112 in a search results region 302 of the display 114. When the user 106 selects 304 a search result 112, the device 108 resizes 306 the search results region 302 to a condensed search results region 308, which presents condensed versions of the search results 112. Additionally, the device 108 present the target 102 of the selected search result 112 on the display 114 in a target region 310 that does not overlap the condensed search results region 308 (e.g., the web browser 114 may be resized to fill a portion of the display 114, and a search results sidebar may be presented to fill the remainder of the display 114). In this exemplary scenario 300, the user 106 may concurrently view the search results 112 and the target 102 of a selected search result 112, without having to take any explicit action to specify the sizes and locations of the respective regions of the display 114. Moreover, if the user 106 selects 314 a second search result 312, the device 108 may alter the presentation 316 by loading the target 102 of the second search result 112 into the target region 310 (replacing the target 102 of the first selected search result 112), thus allowing the user 106 to toggle rapidly among the search results 112 and targets 102 associated therewith.

### C. Exemplary Embodiments

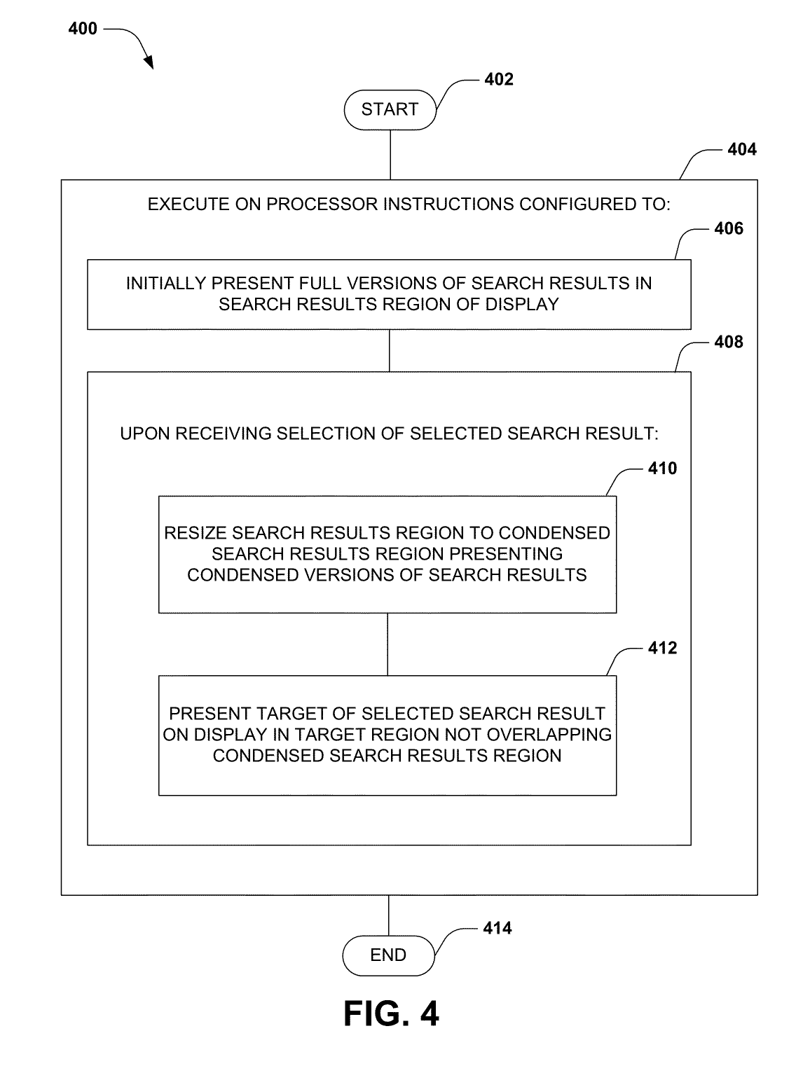

FIG. 4 presents a first exemplary embodiment of the techniques presented herein, illustrated as an exemplary method 400 of presenting search results 112 of a search query 110 in a search results region 302 of a display 114 of a device 108. The instructions may be implemented, e.g., as a set of instructions stored in a memory component of the device 108 (e.g., a memory circuit, a platter of a hard disk drive, a solid-state storage device, or a magnetic or optical disc) that, when executed on a processor of the device 108, causes the device 108 to perform the techniques presented herein. The exemplary method 400 begins at 402 and involves executing 404 the instructions on the processor of the device 108. In particular, the instructions are configured to initially present 406 full versions of the search results 112 in a search results region 302 of the display 114. The instructions are also configured to, upon receiving 408 a selection of a selected search result 112, resize 410 the search results region 302 to a condensed search results region 308 presenting condensed versions of the search results 112; and to present 412 the target 102 of the selected search result 112 on the display 114 in a target region 310 that does not overlap the condensed search results region 308. In this manner, the exemplary method 400 of FIG. 4 causes the device 108 to present search results 112 according to the techniques presented herein, and so ends at 414.

Another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

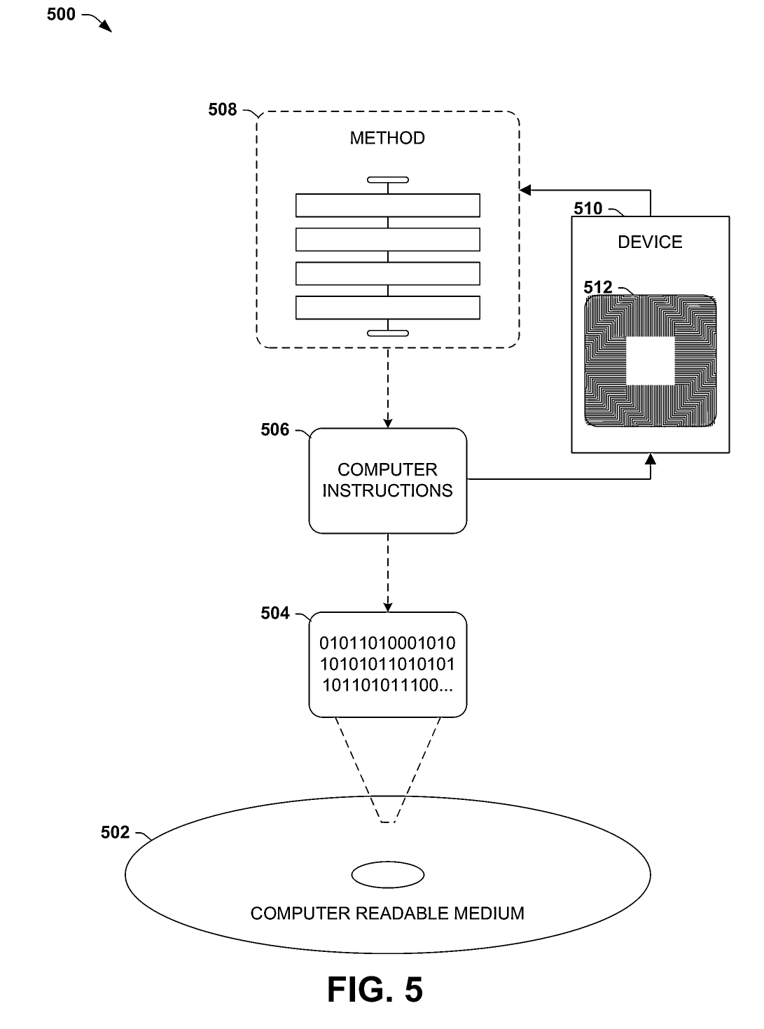

An exemplary computer-readable medium that may be devised in these ways is illustrated in FIG. 5, wherein the implementation 500 comprises a computer-readable medium 502 (e.g., a CD-R, DVD-R, or a platter of a hard disk drive), on which is encoded computer-readable data 504. This computer-readable data 504 in turn comprises a set of computer instructions 506 configured to operate according to the principles set forth herein. Some embodiments of this computer-readable medium may comprise a nontransitory computer-readable storage medium (e.g., a hard disk drive, an optical disc, or a flash memory device) that is configured to store processor-executable instructions configured in this manner that, when executed on a processor 512 of a device 510, cause the device to perform the techniques presented herein. For example, the processor-executable instructions 506 may be configured to cause the device 510 to perform a method of presenting search results in response to a search query, such as the exemplary method 400 of FIG. 4. Many such computer-readable media may be devised by those of ordinary skill in the art that are configured to operate in accordance with the techniques presented herein.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 400 of FIG. 4) to confer individual and/or synergistic advantages upon such embodiments.

D1. Scenarios

A first aspect that may vary among embodiments of these techniques relates to the scenarios wherein such techniques may be implemented.

As a first variation of this first aspect, the targets 102 of the search query 106 may comprise many types of objects in many types of object systems. For example, the targets 102 of the search query 106 may comprise web resources in a network, such as the internet, a particular web domain (such as a particular website), or a local area network (such as an intranet of an organization). Alternatively, the targets 102 may comprise email messages stored in an email message box; files stored in a file system; records in a database system; objects in an object system; or any combination thereof.

As a second variation of this first aspect, the search query 110 may be specified in many ways. For example, the search query 110 may specify a set of keywords to be located within respective fields of the targets 102, or a set of criteria for respective fields of the targets 102 (e.g., a particular sender named in an email message, or a date range for the creation date of a file). The search query 110 may also specify the keywords or other criteria as a logical union (such that a target 102 matching any criterion is selected as a search result 112), a logical intersection (such that a target 102 is only selected as a search result 112 if it matches all criteria of the search query 110), or a logical structure specifying a logic for applying the criteria of the search query 110 to the targets 102. Additionally, the search engine 104 may apply the keywords or search query 110 directly to the respective fields of the targets 102, or may use an approximate or other comparison technique, such as the SOUNDEX algorithm that compares the phonetic equivalents of keywords to the phonetic equivalents of respective fields of the targets 102.

As a third variation of this first aspect, the search engine 104 may comprise a service accessible over a network (such as the internet or a local area network) and configured to receive and fulfill search queries 110 over a particular set of targets 102. Alternatively, the search engine 104 may execute on the device 108, such as a local file search engine 104 provided to apply search queries 110 to the files of a local file system. Some search engines 104 may expansively search targets 102 in many domains, while other search engines 104 may enable the user 106 to specify a domain of targets 102 included in the search (e.g., only searching within a portion of a file system). Those of ordinary skill in the art may devise many such scenarios wherein the techniques presented herein may be utilized.

D2. Presentation of Condensed Search Results Region

A second aspect that may vary among embodiments of these techniques relates to the presentation of the condensed search results region 308.

As a first variation of this second aspect, the resizing 306 of the search results region 302 to the condensed search results region 308 may be illustrated by presenting a visual resizing transition that transforms the search results region 302 to the condensed search results region 308, e.g., a zoom, scale, or cross-fading animation. Alternatively or additionally, the resizing 306 may be indicated by an audial resizing transition, e.g., a sound effect indicating the reduction in size of the search results region 302, and/or a tactile resizing transition, e.g., a vibration that indicates the performance of the resizing operation.

As a second variation of this second aspect, the condensed search results region 308 and the target region 310 may be positioned in various ways that result in a concurrent, non-overlapping presentation. As a first such example, the condensed search results region 308 may comprise a first application region of the display 114, and the target region 310 may comprise a second application region that fills the display 114 excluding the first application region. As a first alternative, the condensed search results region 308 and the target region 310 may not together fill the display 114; e.g., other portions of the display 114 may be reserved for other controls or application regions. As a second alternative, the condensed search results region 308 and the target region 310 may be presented on different displays 114 of the device 108.

As a third variation of this second aspect, the condensed search results region 308 and the target region 310 may be demarcated by a visual partition presented therebetween, e.g., a vertical divider that delineates the regions, or a change in patterns or color schemes that distinguishes the regions. Alternatively, the condensed search results region 308 and the target region 310 may be subtly partitioned (e.g., through a visual gradient presenting a smooth visual transition therebetween).

As a fourth variation of this second aspect, the sizes and/or positions of the condensed search results region 308 and the target region 310 may be arbitrarily selected (e.g., presenting the condensed search results region 308 in the right 25% of the display, and the target region 310 in the left 75% of the display), or according to user-defined default sizes. Alternatively, the sizes and/or positions may be selected based on the size of the display 114 (e.g., adjusting the logical width of the condensed search results region 308 in order to maintain a desired display width, and sizing the target region 310 to fill the remainder of the display) and/or the content presented within either or both regions (e.g., adjusting the widths of the regions based on the widths of the condensed versions of the search results 120 and/or the width of the target 102 presented in the target region 310). These and other properties of the condensed search results region 308 and the target region 310 while implementing the techniques presented herein.

D3. Operations within Condensed Search Results Region

A fourth aspect that may vary among embodiments of these techniques relates to operations that may be received and performed with respect to the condensed search results region 308 and/or the target region 301.

As a first variation of this third aspect, the condensed search results region 308 and the target region 310 may be repositionable and/or resizable by the user 106 or an application (e.g., a vertical divider partitioning the condensed search results region 308 and the target region 310 may be horizontally movable to alter the widths of the regions, or a permitted repositioning of the regions through a “drag” touch operation performed by the user 106). Alternatively, the sizes and/or positions of the condensed search results region 308 and/or the target region 310 may be fixed and not amenable to adjustment.

As a second variation of this third aspect, the input mechanisms of the regions may be adjusted based on the relative positions of the condensed search results region 308 and the target region 310. For example, upon receiving a pointer swipe of a pointing device (e.g., a mouse pointer, a touchpad gesture, or a finger- or stylus-based touch gesture on the display 104) initiated within the condensed search results region 308 near a selected search result 112 and directed toward the target region 310 (e.g., a leftward swipe if the target region 310 is positioned to the left of the condensed search results region 308), the device 108 may present the target 102 of the selected search result 112 in the target region 310.

As a third variation of this third aspect, gestures within the condensed search results region 308 may alter the presentation of search results 112 therewithin. For example, the condensed search results region 308 may initially present the search results 112 along an axis having an axis position, and may initially present a first subset of search results 112 according to an initial axis position. Upon receiving a pointer swipe within the condensed search results region 308 and directed along the axis of the search results 112, the device 108 may update the axis position according to the pointer swipe, and then present a second subset of search results 112 in the condensed search results region 308 according to the updated axis position. As one such example, the condensed search results region 308 may present the search results 112 as a vertically scrollable list, and upon receiving an upward or downward swipe, may scroll the list to a different vertical axis position to present a different subset of search results 112 in the vertically scrollable list.

As a fourth variation of this third aspect, one or more input mechanisms may be provided that enable a user 106 to specify alternative actions that may be performed on the condensed search results region 308, the target region 310, the search query 110, a search result 112, and/or a target of a search result 112. As a first such example, a set of alternative actions may be selectable and performable on a search result 112, such as describing the search result 112 or target 102 thereof; viewing a document source of the target 102; saving the search result 112 as a bookmark or favorite site; or sending the search result 112 to another user 106. Moreover, the input mechanisms for performing alternative actions on a search result 112 may be related to the input mechanisms for simply viewing the target 102 of the search result 112. For example, the device 108 may define a swipe distance threshold, such that, upon receiving a pointer swipe received near a selected search result 112 and comprising a swipe distance from the selected search result 112 that is longer than the swipe distance threshold, causes the device 108 to present the target 102 of the selected search result 112 in the target region 310; while a pointer swipe that is shorter than the swipe distance threshold causes the device 108 to perform an alternative action on the selected search result 112. Additionally, this difference may be visually illustrated by a “tug” animation. For example, while receiving a pointer swipe, the device 108 may depict the pointer swipe by moving the selected search result 112 from an initial position within the search results region 110 (e.g., in the same direction and proportional to the swipe distance). If the pointer swipe exceeds the swipe distance threshold, the selected search result 112 may visually move to the target region 310 while the target 102 is loaded in the target region 310, but if not, the device 108 may return the selected search result 102 to the initial position within the search results region 308 while presenting the alternative actions performable on the selected search result 112.

A particular example of this fourth variation of this third aspect involves the saving of search results 112 and/or targets 102 for re-presentation at a later date. For example, the condensed search results region 308 may present a search result save control that is associated with at least one search result 112. Upon receiving a selection of the search result save control for a selected search result 112, the device 108 may store the selected search result 112 as a saved search result; and upon receiving a request to present a selected saved search result, the device 108 may present the target 102 of the selected saved search result in the target region 310. The saved search results may be presented within various applications (e.g., within a set of saved search results of a web browser 116, or featured in an initial application state of an initial presentation of an application, such as a start page or start screen of an application). Moreover, the saving may involve storing only a reference to the target 102 of the selected search result 112 (e.g., storing the URL), such that the target 102 identified by the URL may be reloaded upon receiving the selection of the saved search result. Alternatively, the storing may include a target state of the target 102 associated with the selected search result (e.g., a snapshot of the target 102 at the time of receiving the request to save the selected search result 112), such that when the saved search result is selected, the target state of the associated target 102 may be presented instead of reloading the target 102, thus preserving the target state of the target 102 (in case the target 102 subsequently changes or is unavailable) and avoiding having to reload the target 102.

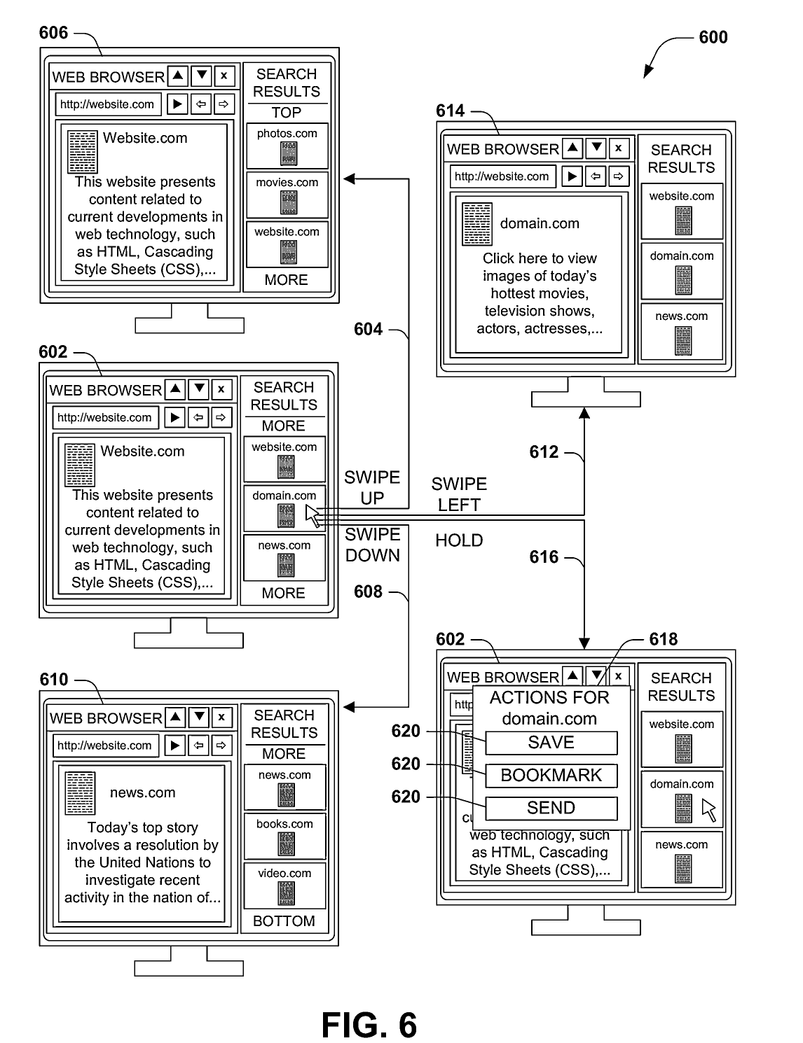

FIG. 6 presents an illustration of an exemplary scenario 600 featuring several of these variations of this third aspect. This exemplary scenario 600 includes a first presentation 602 of a set of search results 112 in response to a search query 110, where a first search result 112 (for a page within the “website.com” domain) has been selected, resulting in a presentation of the target 102 in the target region 310, and a pointer is positioned over a second search result 112 (for a page within the “domain.com” domain”). In this exemplary scenario 600, various gestures may result in different operations. As a first example, an upward pointer swipe 604 may result in a second presentation 606 featuring an upward scrolling of the search results 112 in the condensed search results region 308, and a downward pointer swipe 608 may result in a third presentation 610 featuring a downward scrolling of the search results 112 in the condensed search results region 308. As a second example, a leftward pointer swipe 612 (from the second search result 112 presented in the condensed search results region 308 toward the target region 310) may result in a fourth presentation 614 featuring the target 102 of the second search result 112 loaded into the target region 310. As a third example, a hold 616 of the pointer over the second search result 112 may result in a fifth presentation 618 featuring a set of alternative actions 620 that may be selected with respect to the second search result 310, such as saving the target 102, “bookmarking” the second search result 112, or sending the second search result 112 to another user 106. In this manner, the exemplary scenario 600 illustrates various types of gestures that may be received by the device 108 and result in various types of actions in accordance with the techniques presented herein.

As a fifth variation of this third aspect, the condensed search results region 308 may include a search query control that presents the search query 110, such as a textbox that is automatically loaded with the search query 110. The user 106 may thus view the search query 110 that resulted in the presentation of search results 112. The user 106 may also be permitted to edit and resubmit the search query 110, and upon receiving an updated search query 110 through the search query control, the device 108 may submit the updated search query 110 to the search engine 104, receive search results 112 for the updated search query 110, and replace the search results 112 presented in the condensed search results region 308 for the original search query 112 with search results 112 for the updated search query 110. Moreover, the condensed search results region 308 may facilitate the user 106 in editing the search query 110. As a first such example, the device 108 may present with the search query control at least one suggested search query that is similar to the search query 110 (e.g., a suggested spelling correction of a term in the search query 110). As a second such example, the device 108 may present with the search query control at least one popular search query (e.g., search queries 110 frequently or recently executed by other users 106, or search queries 110 related to the original search query 110 of the user 106). These and other operations with respect to the search results 112 presented in the condensed search results region 308 may be devised while implementing the techniques presented herein.

D4. Implementation

A fourth aspect that may vary among embodiments of these techniques relates to exemplary implementations.

As a first variation of this fourth aspect, a device 108 may be configured in various ways to present the search results 112 according to the techniques presented herein. As a first example, the techniques may be implemented by instructions that are stored on the device 108 and executed in order to present search results 112 presented by a search engine 104. As a second example, the search engine 104 may deliver the instructions to the device 108 to be executed while presenting the search results 112, e.g., as a script or viewer app or applet that is sent or associated with the search results 112 presented in response to the search query 110. As a third example, the instructions may be stored as an application presented by an application store, which the device 106 may retrieve and execute in order to present search results 112 delivered by a search engine 104.

As a second variation of this fourth aspect, the search results 112 delivered by the search engine 104 may be adjusted by the search engine 104 and/or the device 108 for presentation according to the techniques presented herein. For example, the device 108 may construct the condensed versions of respective search results 112 from the full version (e.g., by selecting the first ten words of the full version of each search result 112). Alternatively, the search results 112 sent by the search engine 104 may explicitly include a full version for presentation in the initial search results region 302 and a condensed version for presentation in the condensed search results region 308. As a first alternative, the full versions and condensed versions may be delivered together by the search engine 104, such that the device 108 may refrain from refreshing the search results 112 upon resizing the search results region 302 to the condensed search results region 308, thereby avoiding a delay in the resizing 306 and improving the responsiveness of the device 108. As a second alternative, the full versions and condensed versions may be separately requested and/or received from the search engine 104 (e.g., by specifying a request parameter indicating whether full versions or condensed versions of search results 112 are desired).

As a third variation of this fourth aspect, the search results 112 presented in the search results region 302 and the condensed search results region 308 may be entirely delivered by the search engine 104 in response to the search query 110, or may be iteratively delivered (e.g., the device 108 may initially retrieve from the search engine 104 and present a first subset of search results 112, and when the user 106 scrolls beyond a first subset of search results 112, the device 108 may request and receive from the search engine 104 a second subset of search results 112 to present after the first subset of search results 112).

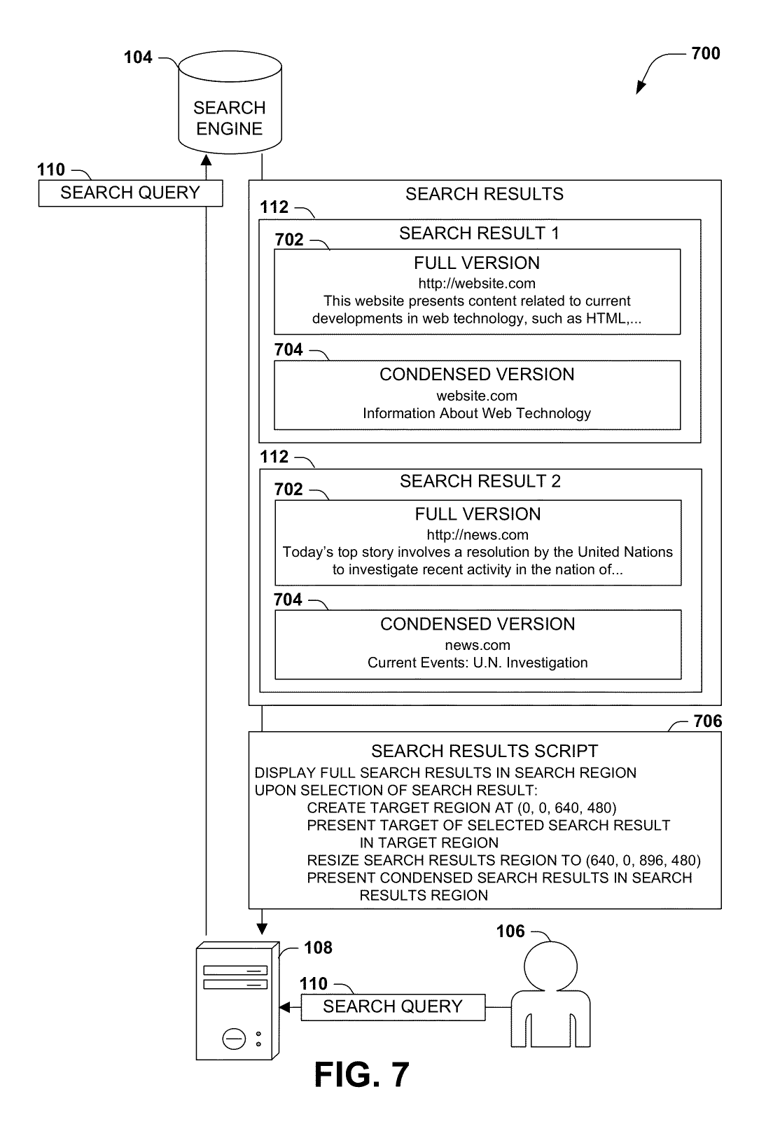

FIG. 7 presents an illustration of an exemplary scenario 700 featuring an exemplary implementation of the techniques presented herein. In this exemplary scenario 700, user 106 submits a search query 110 to a device 108, which submits it to a search engine 104 that provides search results 112. In this exemplary scenario 700, the respective search results 112 presented by the search engine 104 explicitly define a full version 702 and a condensed version 704, such that the device 108 may select the corresponding version of each search result 112 for presenting the search results 112 in either a search result region 302 or a condensed search result region 308 (and without having to re-query the search engine 104 again for different versions of the search results 112). Additionally, the search engine 104 responds to the search query 110 by providing a search results script 706 that may be executed by the device 108 to present the search results 112 according to the techniques presented herein. For example, the search results script 706 may comprise a JavaScript or HTML5 application embedded in the search engine results page that causes a web browser 116 executing on the device 108 to present the search results 112 according to the techniques presented herein. These and other implementation details may be selected by those of ordinary skill in the art while implementing the techniques presented herein.

### E. Computing Environment

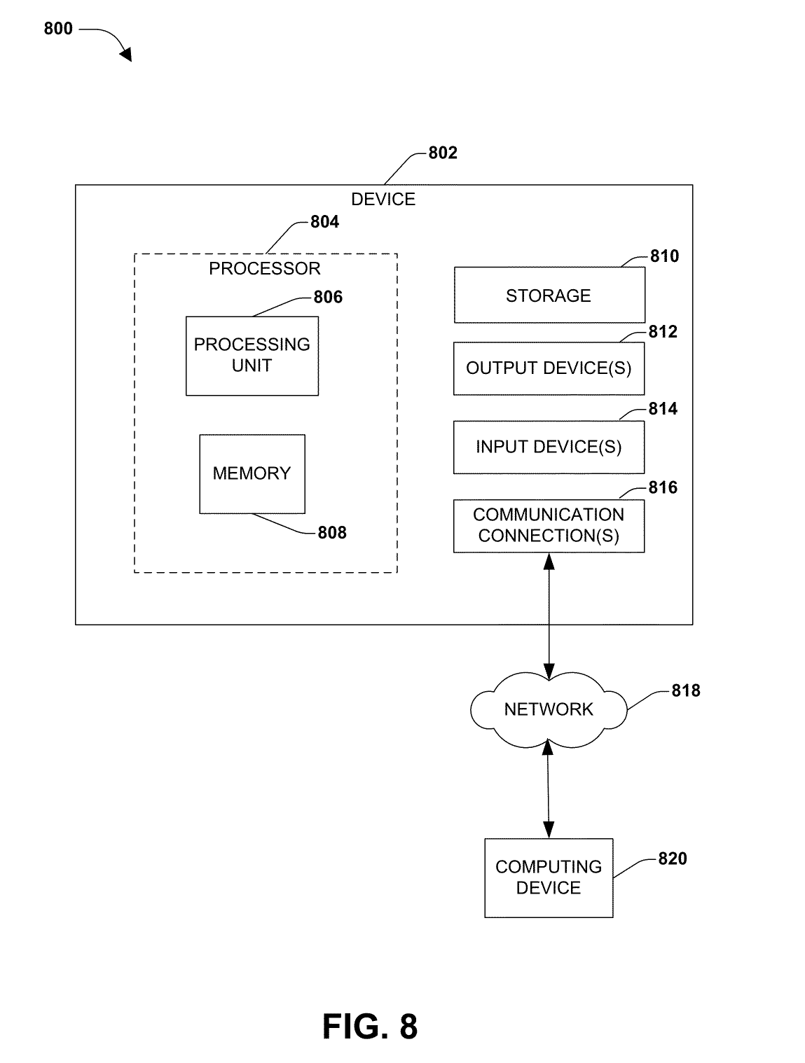

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting search results of a search query in a search results region of a display of a device having a processor, respective search results having a target, the method comprising:
executing on the processor instructions configured to:
initially present full versions of the search results in a search results region of the display; and
upon receiving a selection of a selected search result:
resize the search results region to a condensed search results region presenting condensed versions of the search results; and
present the target of the selected search result on the display in a target region not overlapping the condensed search results region.

2. The method of claim 1, the instructions configured to resize the search results region by presenting a visual resizing transition transforming the search results region to the condensed search results region.

3. The method of claim 1:
the condensed search results region comprising a first application region of the display; and
the target region comprising a second application region filling the display excluding the first application region and comprising a visual partition between the first application region and the second application region.

4. The method of claim 1, receiving the selection of the selected search result comprising: receiving a pointer swipe initiated within the condensed search results region near the selected search result and directed toward the target region.

5. The method of claim 1, the instructions configured to:
upon receiving a pointer swipe received near a selected search result and comprising a swipe distance from the selected search result that is longer than a swipe distance threshold, present the target of the selected search result in the target region; and
upon receiving a pointer swipe received near a selected search result and comprising a swipe distance from the selected search result that is shorter than the swipe distance threshold, perform an alternative action on the selected search result.

6. The method of claim 5, performing an alternative action on a selected search result comprising:
presenting at least two actions associated with the selected search result; and
upon receiving a selection of a selected action, performing the selected action on the selected search result.

7. The method of claim 5, the instructions configured to:
while receiving a pointer swipe, depict the pointer swipe by moving the selected search result from an initial position within the search results region; and
after the pointer swipe comprising a swipe distance from the selected search result that is shorter than the swipe distance threshold, return the selected search result to the initial position within the search results region.

8. The method of claim 1:
the condensed search results region presenting the search results along an axis having an axis position; and
the instructions configured to:
present a first subset of search results in the condensed search results region according to the axis position; and
upon receiving a pointer swipe within the condensed search results region and directed along the axis of the search results:
update the axis position according to the pointer swipe; and
after updating the axis position, present a second subset of search results in the condensed search results region according to the axis position.

9. The method of claim 8:
the device initially storing the first subset of search results received from a search engine in response to the search query; and
the instructions configured to, upon receiving the pointer swipe:
request from the search engine the second subset of search results; and
after receiving the second subset, present the second subset in the condensed search results region.

10. The method of claim 1, the instructions configured to:
present within the search results region a search query control presenting the search query; and
upon receiving an updated search query through the search query control, replace the search results presented in the search results region with search results for the updated search query.

11. The method of claim 10, presenting the search query control comprising: presenting with the search query control at least one suggested search query that is similar to the search query.

12. The method of claim 10, presenting the search query control comprising: presenting with the search query control at least one popular search query.

13. The method of claim 1, comprising:
upon receiving the search query, sending the search query to a search engine; and
receiving the instructions from the search engine with the search results.

14. The method of claim 1, the search engine explicitly specifying, for respective search results, the full version of the search result and the condensed version of the search result.

15. The method of claim 1, the instructions configured to, upon resizing the search results region to the condensed search results region, refrain from refreshing the search results.

16. The method of claim 1, the instructions configured to:
present a search result save control associated with at least one search result;
upon receiving a selection of the search result save control for a selected search result, store the selected search result as a saved search result; and
upon receiving a request to present a selected saved search result, present the target of the selected saved search result in the target region.

17. The method of claim 16:
the instructions configured to, upon initiating an application in an application region, present the application in an application region with an initial application state featuring at least one saved search result; and
receiving the selection of a selected saved search result comprising: receiving a selection of a saved search result presented in the initial application state within the application region.

18. The method of claim 16:
storing the saved search result comprising: storing a target state of the target associated with the selected search result; and
upon receiving a selection of a selected saved search result, present the target state of the selected saved search result in the target region.

19. A computer-readable storage device storing instructions that, when executed on a processor of a device having a display, cause the device to present search results of a search query in a search results region of the display, respective search results having a target, by:
initially presenting full versions of the search results in a search results region of the display; and
upon receiving a selection of a selected search result:
resizing the search results region to a condensed search results region presenting condensed versions of the search results; and
presenting the target of the selected search result on the display in a target region not overlapping the condensed search results region.

20. A method of presenting search results of a search query in a search results region of a display of a device having a processor, respective search results having a target, the method comprising:
executing on the processor instructions configured to:
send the search query to a search engine;
upon receiving from the search engine at least one search result specifying, for respective search results, a full version of the search result and a condensed version of the search result, present full versions of the search results in a search results region of the display;
upon receiving a selection of a selected search result:
refrain from refreshing the search results, present a visual resizing transition transforming the search results region to a condensed search results region;
while refraining from refreshing the search results, resize the search results region to a condensed search results region presenting, within a first application region of the display:
condensed versions of a first subset of the search results, the first subset selected along an axis of the condensed search results region according to an axis position;
a search query control presenting the search query; and
a search result save control associated with at least one search result;
present the target of the selected search result in a target region comprising a second application region filling the display excluding the first application region and comprising a visual partition between the first application region and the second application region;
upon receiving a pointer swipe initiated within the condensed search results region near a second selected search result and directed toward the target region that is longer than a swipe distance threshold, present the target of the second selected search result in the target region of the display;
upon receiving a pointer swipe received near a selected search result and comprising a swipe distance from the selected search result that is shorter than the swipe distance threshold:
present at least two actions associated with the selected search result; and
upon receiving a selection of a selected action, perform the selected action on the selected search result;
upon receiving a pointer swipe within the condensed search results region and directed along the axis of the search results:
update the axis position according to the pointer swipe;
request from the search engine a second subset of search results according to the axis position; and
after receiving the second subset of search results from the search engine, present condensed versions of the second subset of search results in the condensed search results region according to the axis position;
upon receiving an updated search query through the search query control, replace the search results presented in the search results region with search results for the updated search query;
upon receiving a selection of the search result save control for a selected search result:
store the selected search result as a saved search result; and
upon subsequently initiating an application in an application region, present the application in an application region with an initial application state featuring at least one saved search result; and
upon receiving a request to present a selected saved search result, present the target of the selected saved search result in the target region.
